(19) United States
(12) Patent Application Publication
(10) Pub. No.: US 2013/0259434 A1
(43) Pub. Date: Oct. 3, 2013

(54) OVERMOLD BONDING SYSTEM FOR FIBER OPTIC CABLE

(71) Applicants: Anne G. Bringuier, Taylorsville, NC (US); Julian L. Greenwood, III, Hickory, NC (US); Gregory A. Lochkovic, Conover, NC (US); Alvin J. McDonald, Lenoir, NC (US); Lars K. Nielsen, Hickory, NC (US); Hieu V. Tran, Charlotte, NC (US)

(72) Inventors: Anne G. Bringuier, Taylorsville, NC (US); Julian L. Greenwood, III, Hickory, NC (US); Gregory A. Lochkovic, Conover, NC (US); Alvin J. McDonald, Lenoir, NC (US); Lars K. Nielsen, Hickory, NC (US); Hieu V. Tran, Charlotte, NC (US)

(21) Appl. No.: 13/433,607

(22) Filed: Mar. 29, 2012

(51) Int. Cl. G02B 6/255; B29D 11/00

(52) U.S. Cl. 385/99; 264/1.25

(57) ABSTRACT

A fiber optic cable assembly includes a fiber optic cable, a tether, and an overmold. The fiber optic cable includes an optical fiber, a strength member, and a jacket, where the jacket includes an interior portion contacting the strength member and an exterior portion adjoining the interior portion. The interior and exterior portions of the jacket both include polyethylene, and the exterior portion further includes an additive that is not in the interior portion. The tether is coupled to the fiber optic cable at an attachment point. The optical fiber or another optical fiber spliced to the optical fiber, diverges from the fiber optic cable via the tether. The overmold encloses the attachment point and is attached directly to a discrete section of the exterior portion of the jacket proximate to the attachment point. The additive facilitates bonding of the overmold to the discrete section.

### BACKGROUND

The present disclosure relates generally to fiber optic cable assemblies, and more specifically to a system for improving bonding of an overmold to a fiber optic cable, such as at a tether attachment point from a distribution trunk cable or an attachment point of a pig tail or jumper tether to a fiber optic drop cable.

A fiber optic cable assembly typically includes several components. In some cases, a fiber optic cable assembly includes a tether that may be spliced or otherwise coupled to a fiber optic cable for diverting a communication line provided by an optical fiber from the fiber optic cable to an optical fiber of the tether. Typically the tether includes a connector that may then be coupled to hardware in a home, a data center, or elsewhere to send and/or receive high-speed data communicated via the fiber optic cable. An overmold may be provided over the attachment point between the tether and fiber optic cable to secure and support the connection.

A fiber optic cable may be manufactured with a polyethylene jacket that forms the exterior of the fiber optic cable. The tether may likewise have a polyethylene exterior. The overmold however typically includes another material, such as polyurethane, which is cured or otherwise hardened and adhered directly to the jacket of the fiber optic cable and tether when the overmold is applied. However, polyethylene of the jacket and polyurethane of the overmold may be difficult to bond to one another, and a weak seal between the overmold and the jacket of the fiber optic cable or tether may provide an avenue for water or other fluid penetration of the fiber optic cable assembly, which may be undesirable for certain applications.

To improve bonding between the overmold and the jacket of the fiber optic cable or tether, additional manufacturing steps may be used to provide an improved seal. The additional manufacturing steps generally include a surface preparation process for the polyethylene jacket that enhances the bond. For example, manually scuffing or sanding the jacket surface has been found to improve the bond. Alternately or in addition thereto, flame brushing the jacket surface has been found to improve polyurethane bonding. However, such additional process steps are time consuming as well as labor and resource intensive. A need exists for a more efficient method of securely attaching an overmold to a fiber optic cable.

### SUMMARY

One embodiment relates to a fiber optic cable assembly, which includes a fiber optic cable, a tether, and an overmold. The fiber optic cable includes an optical fiber, a strength member, and a jacket. The jacket includes an interior portion contacting the strength member and an exterior portion adjoining the interior portion. The interior and exterior portions of the jacket both include polyethylene, and the exterior portion further includes an additive that is not in the interior portion. The fiber optic cable also includes an attachment point, and the tether is coupled to the fiber optic cable at the attachment point. The optical fiber or another optical fiber spliced to the optical fiber diverges from the fiber optic cable via the tether. The overmold encloses the attachment point and is attached directly to a discrete section of the exterior portion of the jacket proximate to the attachment point (e.g., within one meter thereof). The additive facilitates bonding of the overmold to the discrete section of the exterior portion of the jacket.

Another embodiment relates to a fiber optic cable assembly, which includes a fiber optic cable, a tether, and an overmold. The fiber optic cable includes an optical fiber and a jacket including polyethylene and an additive. The fiber optic cable further includes an attachment point and the tether is coupled to the fiber optic cable at the attachment point. The optical fiber or another optical fiber spliced to the optical fiber diverges from the fiber optic cable via the tether. The overmold encloses the attachment point and is attached directly to the jacket. The additive facilitates bonding of the overmold to a discrete section of the jacket.

Yet another embodiment relates to a method of manufacturing a fiber optic cable assembly. The method includes a step of providing a fiber optic cable including an optical fiber and a jacket including polyethylene and an additive. The method further includes steps of accessing the optical fiber via an attachment point in the jacket and diverting the optical fiber or another optical fiber spliced to the optical fiber from the fiber optic cable via a tether at the attachment point. The method includes a step of enclosing the attachment point with an overmold, where the additive facilitates bonding of the overmold to a discrete section of the jacket.

Additional features and advantages will be set forth in the Detailed Description which follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a perspective view of a fiber optic cable assembly according to an exemplary embodiment.

FIG. 2 is a perspective view of a fiber optic cable according to an exemplary embodiment.

FIG. 3 is a perspective view of a fiber optic cable according to another exemplary embodiment.

FIG. 4 is a perspective view of an attachment point between a fiber optic cable and a tether according to an exemplary embodiment.

FIG. 5 is a perspective view of an overmold surrounding an attachment point according to an exemplary embodiment.

FIG. 6 is a side view of an attachment point of a tether from a distribution trunk cable according to an exemplary embodiment.

FIG. 7 is a sectional view of an attachment point according to another exemplary embodiment.

FIG. 8 is a graph of the amount of bonding force leading to failure of fiber optic cable assemblies at attachment points overmolded according to different methods, where the force identified in the graph was required to pull the cable from the overmold material.

### DETAILED DESCRIPTION

Before turning to the Figures, which illustrate exemplary embodiments in detail, it should be understood that the present invention is not limited to the details or methodology set forth in the Detailed Description or illustrated in the Figures. For example, as will be understood by those of ordinary skill in the art, features and attributes associated with embodiments shown in one of the Figures may be applied to embodiments shown in others of the Figures.

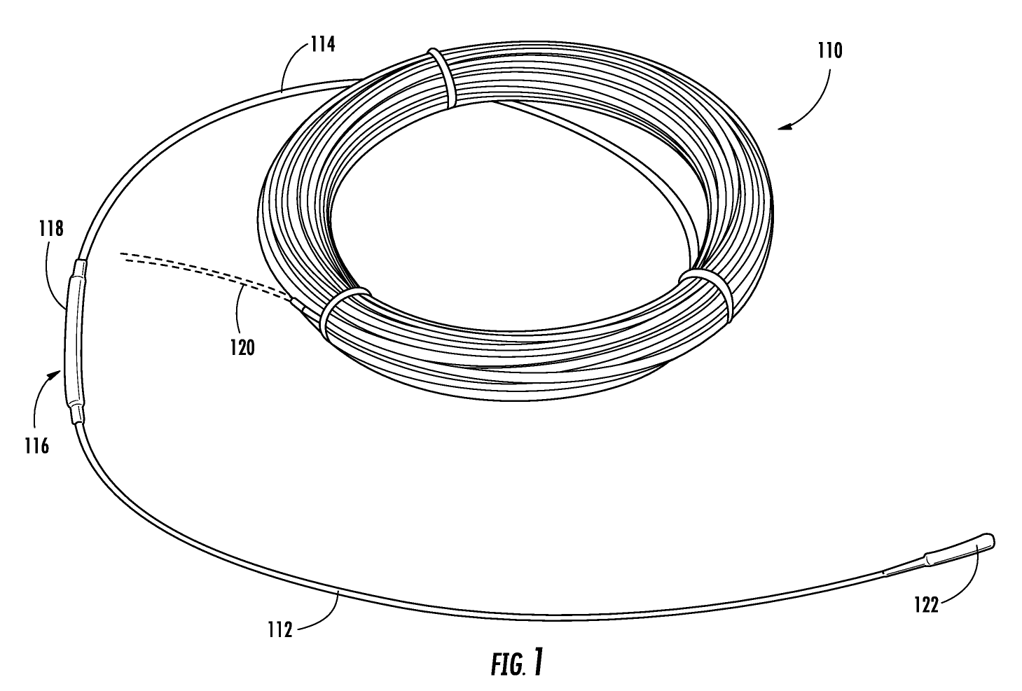

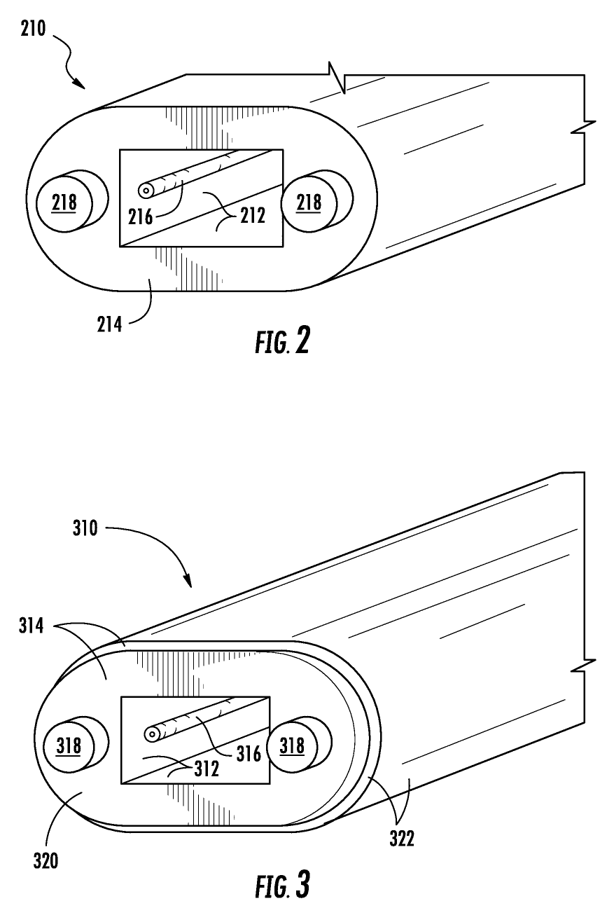

Referring to FIG. 1, a cable assembly 110 (e.g., a long-length OptiTip® cable assembly produced by CORNING CABLE SYSTEMS (see generally FIG. 1); a network access point of a FlexNAP™ cable assembly produced by CORNING CABLE SYSTEMS) includes a tether 112 (e.g., furcation tube, pig tail) attached to a fiber optic cable 114, which may be round, flat, or otherwise shaped, at an attachment point 116 (e.g., demarc area, demarcation). According to an exemplary embodiment, the fiber optic cable 114 includes a communication line in the form of an optical fiber 120 or an array, fixed or otherwise, of optical fibers, extending through a conduit or passage surrounded by a jacket (see, e.g., passage 212 and jacket 214 of fiber optic cable 210, as shown in FIG. 2).

In some embodiments, the fiber optic cable 114 includes several components in addition to the optical fiber 120 and the jacket. The fiber optic cable 114 may include a strength element that provides additional tensile strength to the fiber optic cable 114, such as aramid yarn or glass-reinforced plastic rods (see, e.g., strength member 218 as shown in FIG. 2) that extend lengthwise through the jacket. The fiber optic cable 114 may further include a water-blocking element, such as absorbent powder, water-blocking yarn or tape, gel, or other materials. In some embodiments, the fiber optic cable 114 may include metal or dielectric armor. Sub-unitized optical fiber components, binder yarns, rip cords, central-strength members, and other components may also be included.

According to an exemplary embodiment, the tether 112, similar to the fiber optic cable 114, includes a jacket or exterior that surrounds a communication line, such as an optical fiber (see, e.g., optical fiber 120). In some embodiments, the tether 112 may include fewer optical fibers 120 than the fiber optic cable 114, and may also be narrower and/or of shorter length than the fiber optic cable 114, or of an entirely different geometry altogether. In other contemplated embodiments, the tether 112 and fiber optic cable 114 may be structurally identical to one another. According to an exemplary embodiment, the tether 112 further includes a fiber optic connector 122 (e.g., LC connector, SC connector, MPT connector, HMFOC, or another fiber optic connector) attached to the communication line on a distal end of the tether 112.

The communication line of the fiber optic cable 114 may include a single optical fiber (e.g., bare fiber, colored fiber, tight-buffered fiber) or multiple optical fibers (see, e.g., optical fiber 216 as shown in FIG. 2), such as those connected in a ribbon or those loosely arranged together in the passage 212 or in a buffer tube(s). The ribbon may be one in a stack of ribbons that extend through the fiber optic cable. In other embodiments, the optical fiber is tight-buffered. In contemplated embodiment, the cable 114 supports copper wires or other communication lines or features with or without an optical fiber. Similarly, the tether 112 may include such arrangements of optical fibers or other types of communication or power-conducting lines.

The fiber optic cable 114 and tether 112 may be designed as an indoor cable (e.g., plenum cable, interconnector cable, low-smoke zero-halogen cable, etc.), an outdoor cable (e.g., drop cable), or an indoor/outdoor cable. The cable 114 may be a flat cable (e.g., having longer sides that are generally flat between rounded shorter sides, see generally FIGS. 2-3). In other embodiments, the cable 114 may have a round cross-section, or the cross-section may be otherwise shaped. According to an exemplary embodiment, the jacket of the cable 114 and/or the tether 112 includes a non-polar material, such as polyethylene, polyethylene mixed with carbon black, or another such material.

According to an exemplary embodiment, an overmold 118 secures and/or supports the attachment between the tether 112 and fiber optic cable 114 of the assembly 110 by directly coupling to (e.g., connecting to, attaching to, fastening to, sealing to) the jacket of the fiber optic cable 114 and tether 112 at a discrete section (e.g., segment, portion) of the cable 114 and tether 112. The overmold 118 is a separate component of the assembly 110 from the fiber optic cable 114, covers only a section of the cable 114, and is applied to the already-manufactured cable 114, as opposed to being a layer extruded with and part of the cable 114. Such an overmold 118 may be applied in a factory or in the field.

Referring to FIG. 2, a fiber optic cable 210 (and/or a tether) includes an optical fiber 216 and a jacket 214, where the optical fiber 216 is surrounded by the jacket 214. The jacket 214 may directly contact the optical fiber 216, or may be laterally spaced apart from the optical fiber 216 while still surrounding the optical fiber 216. According to an exemplary embodiment, the jacket 214 forms or includes the exterior-most portion of the fiber optic cable 210 (e.g., outside surface). A strength member(s) 218 (e.g., glass-reinforced plastic rod) is embedded in the jacket. In contemplated embodiments, the cable 210 includes communication lines other than optical fiber. In still other contemplated embodiment, the cable 210 may not a communication, and is instead a furcation tube designed to slide onto an optical fiber when separating fibers from a distribution cable during a furcation process.

According to an exemplary embodiment, the jacket 214 includes (e.g., is formed mostly of or primarily from) polyethylene and an additive configured to facilitate bonding of an overmold (see, e.g., overmold 118 as shown in FIG. 1) to the exterior of the jacket 214. In some embodiments, the additive may also facilitate bonding of other features to the exterior of the jacket 214, such as paint, a nylon skin layer, connector components, or other features. In some embodiments only the jacket 214 of the fiber optic cable 210 includes the additive, and not the tether of an associated assembly. For example, the tether may be formed with a nylon jacket that bonds well with the material of the overmold. In other embodiments, only the exterior of the tether includes the additive, and not the fiber optic cable of an associated assembly.

According to an exemplary embodiment, an additive in the form of a polymer additive is added to the polyethylene cable jacket material to enhance adhesion of an overmold thereto. For example, the cable jacket 214 may include polyethylene with the addition of a polymer compound mixed into the polyethylene prior to or during extrusion of the jacket 214. The polymer compound is intended to increase the adhesion properties of the polyethylene without substantially changing other jacket characteristics, such as strength and permeability. According to an exemplary embodiment, the polymer additive may be compounded into the jacket 214 in a ratio varying from 5% to 15%. In other contemplated embodiments, the polymers may be formed as a separate tie-layer.

In various exemplary embodiments, the additive materials mixed into polyethylene to increase adhesion of the overmold to the jacket 214 include ethylene-acrylic acid copolymers (also called Poly(ethylene-co-acrylic acid) copolymer or PEAA copolymer) with X weight % acrylic acid content, where X is between 5 and 20, (EAA type materials) such as Dow PRIMACOR™ or other EAA type materials; or Polyolefin Plastomers (POP), such as Dow AFFINITY™. According to an exemplary embodiment, the copolymer has carboxylic acid groups (COOH), which modify the surface of the polyethylene. The exterior of the modified polyethylene jacket material will accordingly have these groups that can bond to the polyurethane. The carboxyl group increases adhesion by providing a polar surface to the non-polar polyethylene. The additive may be pre-blended with the jacketing material prior to formation of the jacket 214, and may be extruded directly over (or around and laterally spaced apart from) the optical fiber 216 during manufacturing of the fiber optic cable 210. As such, the additive may be present in the jacket 214 of the fiber optic cable 210 along an entire length of the fiber optic cable 210, as opposed to only in a discrete section of the cable 210 corresponding to an attachment point.

In some embodiments where the additive includes ethylene-acrylic acid polymers, the ethylene-acrylic acid functional groups present on the exterior surface of the jacket 214 promote adhesion to polyurethane. At least some preferred materials for the jacket 214 (or exterior portion thereof) include extrusion-grade polymers with a minimum of 6% by weight of acrylic acid content such as PRIMACOR™ 3003, 3330 and 3340 or extrusion-grade polymers with a minimum of 9% by weight of acrylic acid content, such as PRIMACOR™ 3004 and 3440. Additional grades of EAA may be used, such as film-grade PRIMACOR™ 1410 and 1430 materials, which also contain 9% functional EAA groups.

According to an exemplary embodiment, the jacket 214 requires less than 20% by weight of PRIMACOR™ additive material (e.g., 5-15%, about 10%) to be added to the cable jacket material (e.g., polyethylene) in order to improve bonding and pass industry-standard water penetration tests for the overmold. Applicants have found that the additive may be seamlessly included during the cabling process. Once the cable is made, such as with 10% PRIMACOR™ additive, process steps, such as scuffing, sanding, or flame brushing, for bonding enhancement of the jacket during the overmold process may be eliminated (or enhanced in effectiveness). Elimination of such process steps may also improve product quality through elimination of operator variance. Furthermore, using the additive to improve bonding may require no additional equipment. For example, if the additive is blended on a cabling line, typical pigment hoppers and dryers can be used, which are typically available at industry cabling facilities.

In at least one embodiment, the fiber optic cable is an RPX® furcation tube formed from medium-density polyethylene (MDPE) with an additive, such as 10% by weight Dow PRIMACOR™. The tube may contain fiber ribbons. The additive material is mixed into the MDPE to become material used in the jacket, such as material used throughout the jacket or material used only in an exterior portion of the jacket.

In other embodiments, the additive may include polyolefin plastomers such as Dow AFFINITY™. Polyolefin plastomers (POP) may be used as a polyethylene modifier to increase tack and adhesion of an MDPE jacket. According to an exemplary embodiment, the polyolefin plastomers are compounded into the MDPE compound at a 5-15% ratio, or as a separate tie-layer. At least some grades include Dow AFFINITY™ PT 1450G1 or PT 1451G1.

In contemplated embodiments, a bonding enhancement primer, such as PRIMACOR™, may be manually applied to the exterior surface of the jacket prior to attachment of an overmold, which may improve bonding and prevent water penetration. While included as embodiments herein, such manual application steps may be more time consuming and require additional equipment, when compared to other methods disclosed herein, such as those that include the additive blended directly into the material of the jacket, or a portion of the material of the jacket, and extruded or co-extruded with the jacket during manufacturing of the corresponding fiber optic cable.

Referring now to FIG. 3, a fiber optic cable 310, similar to the fiber optic cable 210 of FIG. 2, includes a jacket 314 and an optical fiber 316. The jacket 314 of the cable 310 includes an interior portion 320 enclosing the strength member 318 and forming a cavity 312 for the optical fiber 316, and an exterior portion 322 adjoining the interior portion 320 on the outside thereof. According to an exemplary embodiment, the exterior portion 322 does not contact the strength member 318.

Still referring to FIG. 3, the interior and exterior portions 320, 322 of the jacket 314 both include polyethylene, and the exterior portion 322 further includes an additive that is not in the interior portion 320. In some embodiments, the interior and exterior portions 320, 322 are discrete (i.e., separate) layers, while in other embodiments the interior portion 320 gradually transitions into the exterior portion 322 from polyethylene, without the additive being present in the interior portion 320 to increasing amounts of the additive being mixed into the polyethylene as a function of proximity to the outside surface of the jacket 314, thus forming the exterior portion 322.

In some embodiments, the interior portion 320 consists of more material (i.e., a greater volume) than the exterior portion 322, such as at least twice as much material. Limiting the additive to the exterior portion 322 saves additive materials, reducing costs while providing an interior structure comparable to standard cables. In some embodiments, the exterior portion 322 uniformly extends a distance of at least 0.5 mm between the interior portion 320 and the outside of the fiber optic cable 310 (e.g., has a thickness of at least 0.5 mm, at least 1 mm, or greater). In other embodiments, the thickness of the exterior portion 322 is less than 0.5 mm, but thicker than a tie layer. The jacket 314 may be manufactured via co-extrusion of the interior and exterior portions 320, 322, or by two (or more) separate passes down an extrusion line(s) where the extruded material is altered between passes or extruders.

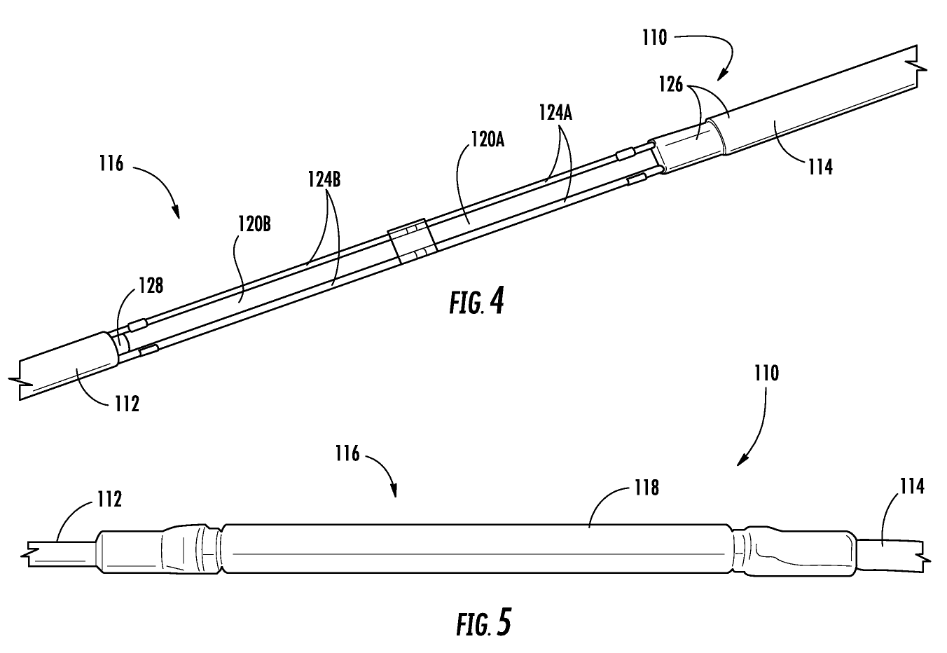

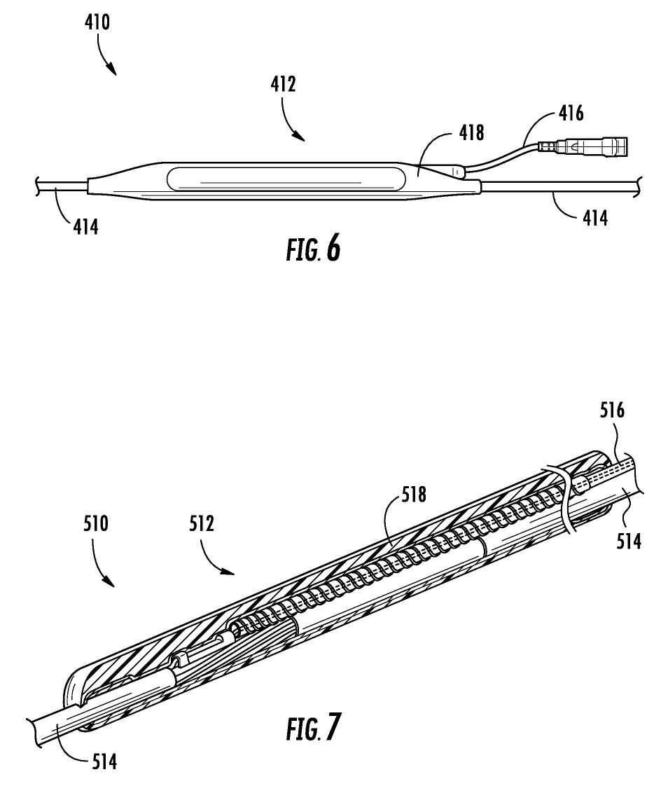

Referring now to FIGS. 4-5, the fiber optic cable assembly 110 of FIG. 1 includes the fiber optic cable 114, the tether 112, and the attachment point 116, where the optical fiber 120A (e.g., plurality of fibers, ribbon(s)) and strength members 124A of the fiber optic cable 114 may be exposed or otherwise accessible to facilitate attachment of the tether 112 to the fiber optic cable 114. Similarly, the optical fiber 120B and strength members 124B of the tether 114 may be exposed or otherwise accessible. In some cases, an end of the jacket 126 may be removed to expose the optical fiber 120A and strength members 124A. In other cases, an intermediate section of the jacket 126 that is not on an end of the jacket 126 may be opened to expose the optical fibers 120A and strength members 124A (see generally FIGS. 6-7).

According to an exemplary embodiment, the optical fiber 120B of the tether 112 and the optical fiber 120A of the fiber optic cable 114 are joined to one another (e.g., spliced, connected). In some embodiments, heat shrinks 126 or other enclosures are used to hold the strength members 124A, 124B (e.g., glass-reinforced plastic rods) in position prior to applying the overmold 118 around the attachment point 116. A rectangular protecting tube 128 may be used to prevent the un-cured or fluid overmold material (e.g., polyurethane) from entering the cavity of the cable 114 or tether 112, and also to control excess ribbon or fiber length in the area of the attachment point 116. In some embodiments, ribbons of optical fibers 120A, 120B are locked onto the cable jacket 126 via an ultra-violet curable adhesive in order to eliminate cable-influenced factors to the connector (see, e.g., connector 122 as shown in FIG. 1), such as strain and shrinkage. In other embodiments, the optical fiber 120A from the fiber optic cable 114 is inserted into a cavity or tube to form the optical fiber of the tether 112, and then the overmold 118 is applied to secure the attachment of the tether 112 and fiber optic cable 114.

Referring now to FIGS. 6-7, cable assemblies 410, 510 (e.g., tether attachment points from a distribution trunk cable including an OptiTip® Tether Assembly manufactured by CORNING CABLE SYSTEMS) include an attachment point 412, 512 joining a fiber optic cable 414, 514 and a tether 416, 516, supported and secured by an overmold 418, 518. During attachment of the overmold 418, 518, a discrete (e.g., isolated, partial) lateral portion or section of the fiber optic cable 414, 514 is opened to provide access to an optical fiber (or fibers) within the cable 414, 514. The optical fiber is diverted to or spliced with a fiber in the tether 416, 516. The overmold 418, 518 is then applied to support and secure the attachment.

According to an exemplary embodiment, the jacket of the fiber optic cable 414, 514 (and/or the tether 416, 516) is at least partially formed by pre-blending of an additive and polyethylene, where the additive is an ethylene-acrylic acid polymer or a polyolefin plastomer, and where the additive improves bonding of the overmold 418, 518 to the fiber optic cable 414, 514 and/or tether 416, 516 at the attachment point 412, 512. In some embodiments, multiple tethers 416, 516 are attached to the fiber optic cable 414, 514 at the attachment point 412, 512, such as two or more, and secured and supported by the same overmold 418, 518.

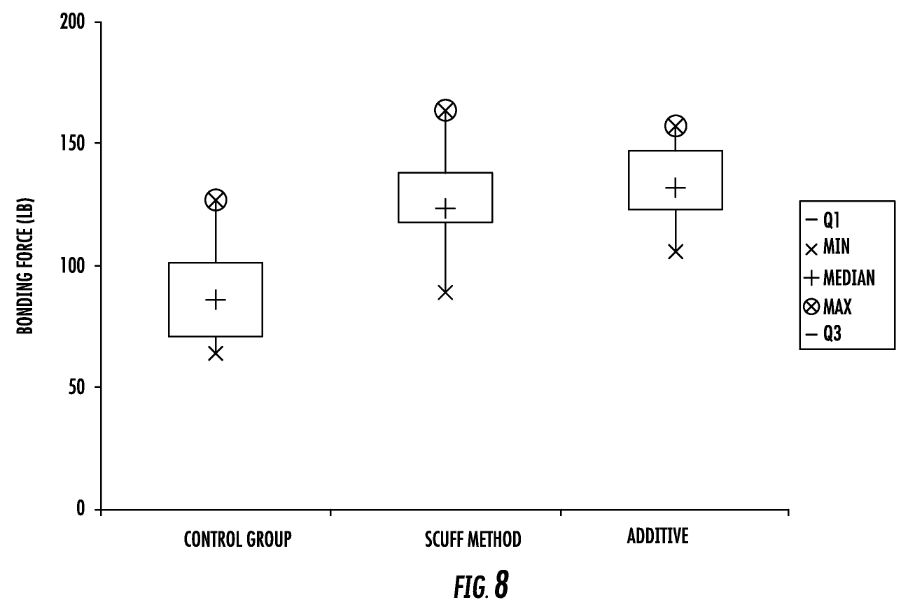

Referring to FIG. 8, adhesion testing was used to evaluate the bond strength of cable jackets and overmolds as disclosed herein. Test samples were characterized in adhesion testing and compared with a control group using the unmodified MPDE material (i.e., without a bond-enhancing additive). The bonding force shown in FIG. 8 is defined as the force required for pulling out of a cable from a PVC pipe filled with overmold material when using 10 mm length cable. The testing showed an MDPE jacket, including 10% by weight of PRIMACOR™ additive, produced a significantly higher bonding force to the overmold when compared to unmodified MDPE material, and produced a less-variable bond when compared to mechanical scuff treatment. Furthermore, the test samples with the additive material passed the water immersion tests, while comparable unmodified MDPE jackets failed at a 50% rate.

Also as shown in FIG. 8, testing revealed that scuff treatment of the jacket yields improved bonding force as well, but showed greater variance of results than the additive approach disclosed herein. As such, the additive bond enhancement to the cable jacket may replace or remove the need for cable assembly processing steps (e.g., scuffing and flame brushing) and may also have lower net cost impact in resources, time, and efficiency than other methods.

Fiber-to-the-X (FTTX) products may be exposed to outdoor environmental conditions, such as those specified in TELECORDIA GR(s) standard test documents. In testing, the increased adhesion provided by the bond-enhancing additive in the polyethylene jacket allowed an OptiTip® long-length pig tail to pass the GR3152 water immersion and freeze/thaw tests. Better adhesion of the cable jacket material (polyethylene) to the overmold products is important during temperature cycling and water immersion. Furthermore, many components in addition to overmolds may be attached to a cable jacket, such as heat shrinks and boots, the attachment and bonding forces for which may be strengthened by the teachings disclosed herein.

In contemplated embodiments, the modified PE jacketing layer may provide benefits to the internal components of the cable. For example, PE containing EAA could be used with uncoated GRP strength member rod to achieve similar bond to the EAA-coated GRP used in some conventional cables. Also, some current cable designs use foam tape or swell binders to provide ribbon coupling and water-blocking. The EAA additive may increase friction between the cavity wall and the tape/binder, thus increase coupling, such as for RPX® cables manufactured by CORNING CABLE SYSTEMS, as discussed in International Application PCT/US06/29716 filed Jul. 27, 2006, which is incorporated by reference herein in its entirety. As such, in addition to improving adhesion, the additive will increase tack and the interior cavity may be less slick.

In some embodiments, in addition to the additive to improve PE bonding, the material of the jacket further includes a tackifier, such as polyisobutene into the polyethylene, to increase the tack of the modified polyethylene and to subsequently prevent water penetration into the assembly. The tackifier can be added like a color chip at a rate of 2 to 5% of the jacket material by weight. In other embodiments, a greater or lesser amount of tackifier is used, such as no tackifier. In various contemplated embodiments, the tackifier may only be provided to the interior portion of the jacket, only to the exterior portion of the jacket, or throughout the jacket.

The construction and arrangements of the coating removal system for optical fiber, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. In contemplated embodiments, the jacketing materials, cable structures, and techniques disclosed herein apply to a cable access point wherein fibers or other data-transfer media are accessed, then subsequently overcoated with a protective material, such as an overmold sheath. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A fiber optic cable assembly, comprising:
a fiber optic cable, comprising:
an optical fiber;
a strength member; and
a jacket, wherein the jacket comprises an interior portion contacting the strength member and an exterior portion adjoining the interior portion, wherein the interior and exterior portions of the jacket both comprise polyethylene and the exterior portion further comprises an additive that is not in the interior portion; and
wherein the fiber optic cable comprises an attachment point;
a tether coupled to the fiber optic cable at the attachment point, wherein the optical fiber or another optical fiber spliced to the optical fiber diverges from the fiber optic cable via the tether; and
an overmold enclosing the attachment point, wherein the overmold is attached directly to a discrete section of the exterior portion of the jacket proximate to the attachment point, and wherein the additive facilitates bonding of the overmold to the discrete section of the exterior portion of the jacket.

2. The fiber optic cable assembly of claim 1, wherein the overmold comprises polyurethane, and the additive bonds the polyurethane and polyethylene of the jacket.

3. The fiber optic cable assembly of claim 1, wherein the exterior portion is a discrete layer of the jacket.

4. The fiber optic cable assembly of claim 3, wherein the interior portion has a greater volume than the exterior portion.

5. The fiber optic cable assembly of claim 4, wherein the exterior portion defines the outermost surface of the fiber optic cable.

6. The fiber optic cable assembly of claim 1, wherein the additive is an ethylene-acrylic acid polymer or a polyolefin plastomer.

7. The fiber optic cable assembly of claim 6, wherein the exterior portion of the jacket includes less than 20% by weight of the additive.

8. The fiber optic cable assembly of claim 7, wherein the exterior portion of the jacket includes between 5 to 15% by weight of the additive.

9. The fiber optic cable assembly of claim 8, wherein the jacket further comprises a tackifier blended with the polyethylene.

10. The fiber optic cable assembly of claim 9, wherein the tackifier is polyisobutene.

11. The fiber optic cable assembly of claim 10, wherein the tackifier is mixed into the polyethylene prior to extrusion, and wherein the tackifier is provided at a rate of 2 to 5% by weight of the corresponding jacketing material.

12. A fiber optic cable assembly, comprising:
a fiber optic cable, comprising:
an optical fiber; and
a jacket, comprising polyethylene and an additive; and
wherein the fiber optic cable comprises an attachment point;
a tether coupled to the fiber optic cable at the attachment point, wherein the optical fiber or another optical fiber spliced to the optical fiber diverges from the fiber optic cable via the tether; and
an overmold enclosing the attachment point, wherein the overmold is attached directly to a discrete section of the jacket, wherein the additive facilitates bonding of the overmold to the discrete section of the jacket.

13. The fiber optic cable assembly of claim 12, wherein the jacket includes between 5 to 15% by weight of the additive.

14. A method of manufacturing a fiber optic cable assembly, comprising:
providing a fiber optic cable comprising:
an optical fiber; and
a jacket comprising polyethylene and an additive;
accessing the optical fiber via an attachment point in the jacket;
diverting the optical fiber or another optical fiber spliced to the optical fiber from the fiber optic cable via a tether at the attachment point; and
enclosing the attachment point with an overmold, wherein the additive facilitates bonding of the overmold to a discrete section of the jacket.

15. The method of claim 14, wherein the fiber optic cable further comprises a strength member and the jacket comprises an interior portion contacting the strength member and an exterior portion adjoining the interior portion, wherein the interior and exterior portions of the jacket both comprise polyethylene and the exterior portion further comprises the additive but the interior portion does not.

16. The method of claim 15, wherein the exterior portion is a discrete layer of the jacket.

17. The method of claim 16, further comprising forming the fiber optic cable by steps comprising co-extruding interior and exterior portions of the jacket around the optical fiber and the strength member, wherein the interior portion contacts the strength member and the exterior portion adjoins the interior portion.

18. The method of claim 17, wherein the forming step further comprises pre-blending of the additive and polyethylene.

19. The method of claim 18, wherein the additive is an ethylene-acrylic acid polymer or a polyolefin plastomer.

20. The method of claim 19, wherein the interior portion has a greater volume than the exterior portion.
